(19) United States
(12) Patent Application Publication
(10) Pub. No.: US 2020/0282352 A1
(43) Pub. Date: Sep. 10, 2020

(54) FILTER MOUNT

(71) Applicant: Matthew Philip Davidson, St Petersburg, FL (US)

(72) Inventor: Matthew Philip Davidson, St Petersburg, FL (US)

(21) Appl. No.: 16/670,150

(22) Filed: Oct. 31, 2019

Related U.S. Application Data
(60) Provisional application No. 62/814,506, filed on Mar. 6, 2019.

(51) Int. Cl. B01D 46/00; F24F 1/035; F24F 13/08

(52) U.S. Cl. CPC B01D 46/0008; F24F 13/084; F24F 1/035

(57) ABSTRACT

A filter mount includes a base, which is a flat plate that has a vent grille to allow airflow to pass through. A sidewall is perpendicular to and upstands from a periphery of the base. The sidewall includes an upper edge defining an opening leading into a filter receptacle defined by the sidewall and the base. The sidewall further includes a slot leading into the filter receptacle. An internal filter support is coupled within the filter receptacle and defines a channel configured to guide and retain a pre-filter placed through the slot and into the filter receptacle. A high-efficiency particulate air receptacle is defined within the filter receptacle in between the internal filter support and the upper edge of the sidewall. A connector is configured to couple the filter mount to a portable air conditioner in front of an air intake evaporator.

### CROSS-REFERENCE TO RELATED APPLICATION

This application claims the benefit of priority of U.S. provisional application No. 62/814,506, filed Mar. 6, 2019, the contents of which are herein incorporated by reference.

### BACKGROUND OF THE INVENTION

The present invention relates to air conditioning filters and, more particularly, to a filter mount to mount additional filters to portable air conditioners.

Current commercial portable air conditioners (spot coolers) use basic filtration or use filtration mechanisms that are built internally into the product. High-efficiency particulate air (HEPA) filters are currently not used with portable air conditioners. Without HEPA filtration, the air quality is substandard and not acceptable to many customers that use commercial portable air conditioners.

As can be seen, there is a need for a filter mount to mount additional filters to portable air conditionings.

### SUMMARY OF THE INVENTION

In one aspect of the present invention, a filter mount comprises: a base comprising a vent grille; a sidewall perpendicular to and upstanding from a periphery of the base and comprising an upper edge defining an opening, the sidewall and the base defining a filter receptacle, wherein a slot is defined through the sidewall and leads into the filter receptacle; an internal filter support coupled within the filter receptacle and defining a channel configured to guide and retain a pre-filter placed through the slot and into the filter receptacle, wherein a high-efficiency particulate air receptacle is defined within the filter receptacle in between the internal filter support and the upper edge of the sidewall; and a connector configured to couple the filter mount to a portable air conditioner in front of an air intake evaporator.

In another aspect of the present invention, a method of attaching additional filters to a portable air conditioner comprises: providing a filter mount comprising: a base comprising a vent grille; a sidewall upstanding from the base and comprising an upper edge defining an opening, the sidewall and the base defining a filter receptacle; inserting a pre filter into the filter receptacle against the vent grille; inserting a high-efficiency particulate air filter into the filter receptacle against the pre filter; and coupling the filter mount to a portable air conditioner so that the filter mount covers an air intake evaporator of the portable air conditioner.

These and other features, aspects and advantages of the present invention will become better understood with reference to the following drawings, description and claims.

### BRIEF DESCRIPTION OF THE DRAWINGS

FIG. 1 is an exploded perspective view of an embodiment of the present invention;

FIG. 2 is a perspective view of an embodiment of the present invention;

FIG. 3 is a perspective view of an embodiment of the present invention; and

FIG. 4 is a perspective view of an embodiment of the present invention, illustrating insertion of a high-efficiency particulate air filter.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a filter mount that secures a HEPA filter to a commercial portable air conditioner, such as a spot cooler. The filter mount of the present invention mounts a HEPA filter quickly and easily to the evaporator section of a commercial portable air conditioner with couplers. The present invention provides premium HEPA filtration of 99.97% at 0.3 micron.

The filter mount incorporates a pre-filter and a HEPA filter. The filter mount incorporates the pre-filter by sliding the pre-filter through the side of the filter mount. The HEPA filter is set into the filter mount before attaching the filter mount to the commercial portable air conditioner. The present invention is easily installed over the evaporator section and provides HEPA filtration across the evaporator section of the unit. These commercial portable air conditioners are commonly used by Hospitals, Medical Facilities, clean rooms, restoration and many other types of applications needing high levels of filtration beyond what is currently available. The present invention improves Indoor Air Quality (IAQ) dramatically.

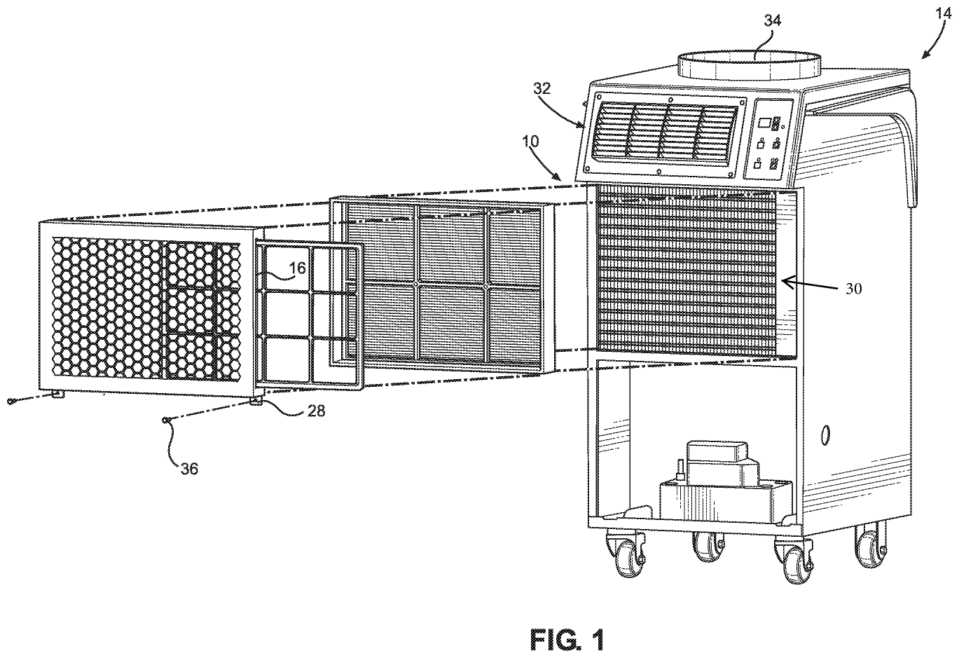

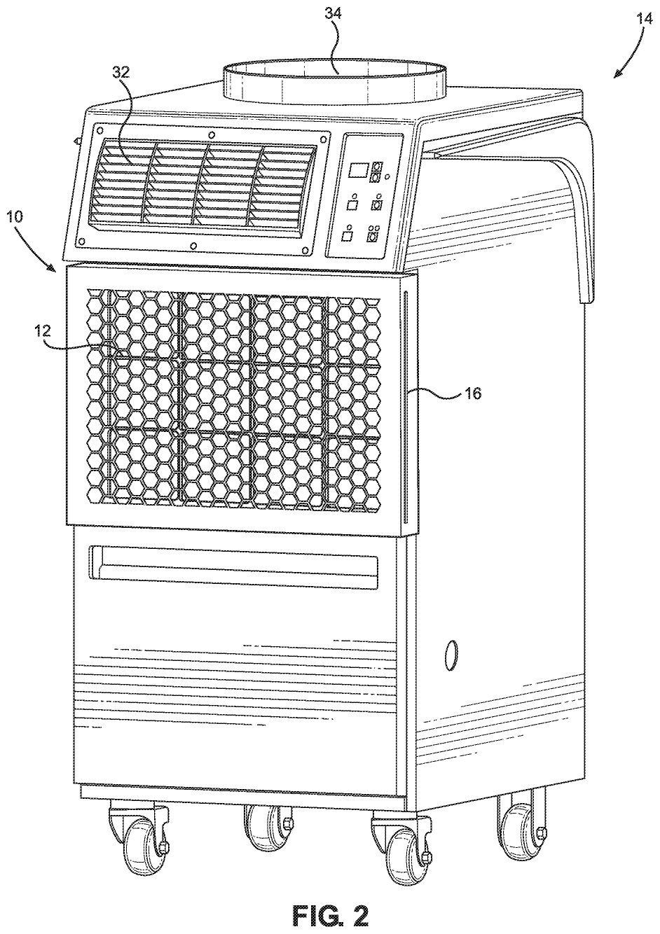

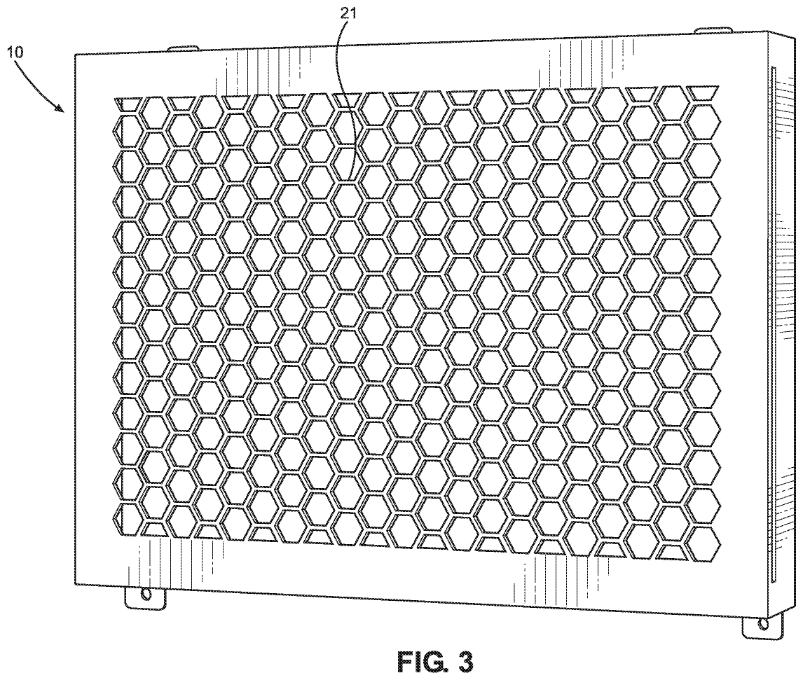

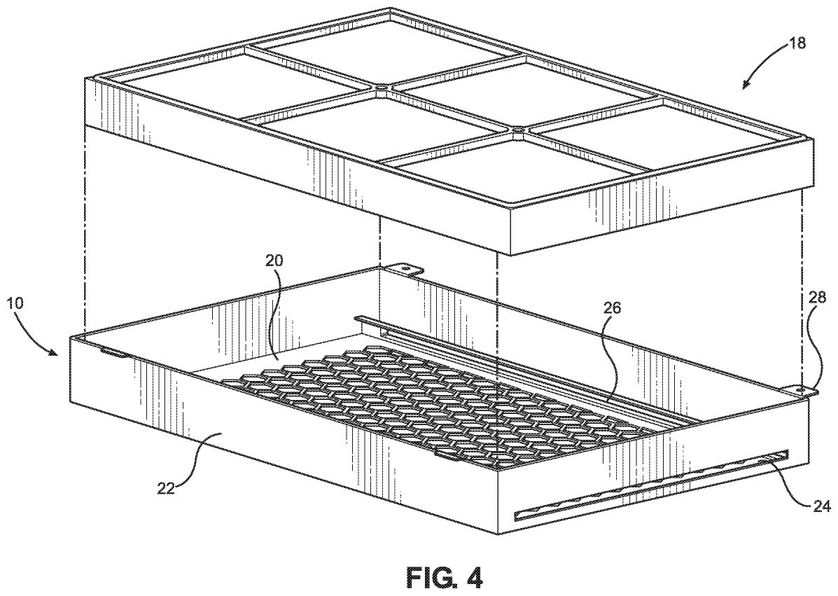

Referring to FIGS. 1 through 4, the present invention includes a filter mount 10. The filter mount 10 includes a base 20, which is a flat plate that has a vent grille 21 to allow airflow to pass through. A sidewall 22 is perpendicular to and upstands from a periphery of the base 20. The sidewall 22 includes an upper edge defining an opening leading into a filter receptacle defined by the sidewall 22 and the base 20. The sidewall 22 further includes a slot 24 leading into the filter receptacle. An internal filter support 26 is coupled within the filter receptacle and defines a channel configured to guide and retain a pre-filter 12 placed through the slot 24 and into the filter receptacle. A high-efficiency particulate air receptacle is defined within the filter receptacle in between the internal filter support 26 and the upper edge of the sidewall 22. A connector 28, 36 is configured to couple the filter mount 10 to a portable air conditioner 14 in front of an air intake evaporator 30.

The sidewall 22 may have a rectangular shape that includes a first side, a second side, a top side and a bottom side. In such embodiments, the slot 16 may be defined through the first side or the top side. The connector 28, 36 may include a plurality of tabs 28 extending from the top side and the bottom side. A pair of tabs 28 extending from the bottom side may each include openings. Bolts 36 may run through the openings of the tabs 28 and couple the filter mount 10 to the portable air conditioner 14.

A method of attaching additional filters to a portable air conditioner 14 may include the following. A portable air conditioner 14 includes an air intake evaporator 30, an output 32, and an exhaust 34. Provide the filter mount 10 described above. The filter mount 10 includes the base 20 with the vent grille 21 and the sidewall 22 upstanding from the base 20 and having the upper edge defining the opening. The sidewall 22 and the base 20 define a filter receptacle. The slot 24 is defined through the sidewall 22 and leads into the filter receptacle. The internal filter support 26 is coupled within the filter receptacle and defines the channel aligned with the slot 24. Insert a pre-filter 12 into the filter receptacle by sliding the pre-filter 12 through the slot 24 and into the channel. Insert a high-efficiency particulate air filter 18 into the filter receptacle, sandwiching the pre-filter 12 in between the high-efficiency particulate air filter 18 and the vent grille 21. Couple the filter mount 10 to a portable air conditioner 14 by driving bolts 36 through the openings of the tabs 28 and into the portable air conditioner 14 so that the filter mount 10 covers the air intake evaporator 30 of the portable air conditioner 14.

A method of making the present invention may include the following. The filter mount 10 may be made by specific dimensions of fabrication in a factory. The filter mount 10 may be punched and welded to specific specifications. Furthermore, the pre-filter 12 and HEPA filter 18 that fit into filter mount 10 may also be designed with specific dimensions and tolerances to fit into the filter mount 10. Furthermore, the filter mount 10 may be manufactured and engineered to both filter at 99.97% at 0.3 micron or greater and fit the panel securely to make an airtight seal on the evaporator section of the commercial portable air conditioner 14.

It should be understood, of course, that the foregoing relates to exemplary embodiments of the invention and that modifications may be made without departing from the spirit and scope of the invention as set forth in the following claims.

What is claimed is:

1. A filter mount comprising:
a base comprising a vent grille;
a sidewall perpendicular to and upstanding from a periphery of the base and comprising an upper edge defining an opening, the sidewall and the base defining a filter receptacle, wherein a slot is defined through the sidewall and leads into the filter receptacle;
an internal filter support coupled within the filter receptacle and defining a channel configured to guide and retain a pre-filter placed through the slot and into the filter receptacle, wherein a high-efficiency particulate air receptacle is defined within the filter receptacle in between the internal filter support and the upper edge of the sidewall; and
a connector configured to couple the filter mount to a portable air conditioner in front of an air intake evaporator.

2. The filter mount of claim 1, wherein the sidewall comprising a first side, a second side, a top side and a bottom side, wherein the slot is defined through the first side.

3. The filter mount of claim 2, wherein the connector comprises a plurality of tabs extending from the bottom side, wherein the plurality of tabs comprising openings.

4. The filter mount of claim 3, wherein the connector further comprises bolts that run through the openings.

5. A method of attaching additional filters to a portable air conditioner comprising:
providing a filter mount comprising:
a base comprising a vent grille;
a sidewall upstanding from the base and comprising an upper edge defining an opening, the sidewall and the base defining a filter receptacle;
inserting a pre-filter into the filter receptacle against the vent grille;
inserting a high-efficiency particulate air filter into the filter receptacle against the pre-filter; and
coupling the filter mount to a portable air conditioner so that the filter mount covers an air intake evaporator of the portable air conditioner.

6. The method of claim 5, wherein a slot is defined through the sidewall and leads into the filter receptacle and an internal filter support is coupled within the filter receptacle and defines a channel aligned with the slot.

7. The method of claim 6, wherein the step of inserting the pre-filter into the filter receptacle comprises sliding the pre-filter through the slot and into the channel.

8. The method of claim 6, wherein the sidewall comprising a first side, a second side, a top side and a bottom side, wherein the slot is defined through the first side.

9. The method of claim 5, wherein the filter mount further comprises tabs with openings extending laterally from the sidewall.

10. The method of claim 9, wherein the step of coupling the filter mount to the portable air conditioner comprises driving bolts through the openings of the tabs and into the portable air conditioner.
